(19) United States
(12) Patent Application Publication
(10) Pub. No.: US 2009/0009475 A1
(43) Pub. Date: Jan. 8, 2009

(54) WIRELESS COMPUTER MOUSE WITH BATTERY SWITCHING CAPABILITY

(75) Inventor: Franz Michael Schuette, Colorado Springs, CO (US)

Correspondence Address: HARTMAN & HARTMAN, P.C., 552 EAST 700 NORTH, VALPARAISO, IN, 46383, US

(73) Assignee: OCZ TECHNOLOGY GROUP, INC., Sunnyvale, CA (US)

(21) Appl. No.: 12/166,498

(22) Filed: Jul. 2, 2008

Related U.S. Application Data
(60) Provisional application No. 60/948,212, filed on Jul. 6, 2007.

(51) Int. Cl. G06F 3/033

(52) U.S. Cl. 345/163; 455/41.2

(57) ABSTRACT

A wireless mouse suitable for use with a computing device, and method of using such a mouse. The mouse includes a housing, electronics within the housing for sensing movement of the mouse and wirelessly communicating with the computing device, at least two batteries within the housing, a device for monitoring a power level of each of the batteries, and a device for switching between the batteries to deliver electrical power from one of the batteries to the electronics. Each battery is adapted for individually powering the electronics, and the switching device operates to switch from a first of the batteries to a second of the batteries when the power level of the first battery sensed by the monitoring device drops below a preset depletion threshold value.

### CROSS REFERENCE TO RELATED APPLICATIONS

This application claims the benefit of U.S. Provisional Application No. 60/948,212, filed Jul. 6, 2007, the contents of which are incorporated herein by reference.

### BACKGROUND OF THE INVENTION

The present invention generally relates to wireless, battery-powered electronic devices. More particularly, this invention relates to a wireless computer mouse equipped with multiple batteries and the ability to automatically switch between batteries when a low-power condition is encountered.

Modern personal computers (PCs) typically employ two primary types of input devices, namely, a keyboard and a pointing device, the latter of which is a mouse in most cases. Early generations of mice used rubber balls to translate lateral movements into X-Y coordinates on the computer screen, and were interfaced primarily via a serial COM port interface. Later generations of mice used the PS2 interface, which have since been succeeded by the universal serial bus (USB) port as the primary interface for electrically connecting computer peripherals of all sorts and providing power to those peripherals. The capability to draw power off the main computer has spawned all kinds of technological advancements in peripherals including mass storage devices, scanners, and optical mice.

The majority of optical mice currently use the above described USB interface for its supply power, wherein the USB cord also serves as a cable for data transfer. An advantage of this design is that there are no concerns for power conservation, so that the mouse can constantly transmit data over the cable to the computer. However, a drawback is that the cable causes friction or can become tangled with other devices and objects in the area where the mouse is used, such as a desktop. In response, wireless mice have been developed that typically use radio frequency (RF) communication with a receiver that is relatively stationary. The term “wireless” is used herein to denote a mouse that lacks a physical connection (for example, a cable) to the rest of the computer system, and therefore requires its own power source, typically a battery, though other forms of power supplies exist.

Electronic devices that rely on battery power often employ some type of battery management system to prolong the life of the battery. For example, battery management techniques have been used for decades in portable electronic devices, primarily camera systems. U.S. Pat. No. 5,164,761 to Isono et al. describes a battery system for a camera that uses two batteries, with the second battery providing backup power when the first battery is depleted. U.S. Pat. No. 5,517,277 to Goto et al. discloses circuitry that disconnects a first battery from a camera system when a depletion threshold is reached, and switches over to a second battery system supplied separately from the first battery. U.S. Pat. No. 5,847,566 to Maritt et al. disclose a method for calculating the residual battery capacity of a battery, and U.S. Pat. No. 7,064,522 to Nawa et al. discloses an indicator for the residual capacity of a battery in an electronic system.

Battery management systems employed with wireless mice and many other battery-powered electronics typically include features that allow these devices to go into a standby or sleep mode to preserve battery power if the device is not in active use. On receiving an input from a user, for example, movement of the mouse, the device wakes up and goes into a fully functional power mode. However, the transition from sleep mode to power mode can take a few cycles. In the case of wireless mice, in which lack of activity for even a few seconds can result in powering-down and entering sleep mode, the resulting response lags have resulted in a negative perception. This negative aspect is particularly prominent in wireless optical mice that consume additional energy through the use of LEDs to measure motion.

Another issue contributing to the perceived shortcomings of wireless optical mice is that upon reaching a certain threshold of battery charge or discharge, the mouse often stops working without warning. In an office environment, this may not be a catastrophic event since there is usually time to change the battery and resume work. However, in critical real-time environments such as data acquisition, navigation, or gaming applications, the sudden death of the mouse can have negative consequences, such as losing a bid, voiding a scientific experiment, or simply losing a match in a computer game.

Several commercially available solutions exist to address the issue of low battery power to a wireless mouse. For example, Logitech's line of Laser Mouse and others utilize rechargeable (secondary) batteries and a cradle into which the mouse can be positioned during periods of non-use. The cradle is equipped with a built-in battery charger that automatically recharges the mouse when cradled. While effective in principle, this solution incurs extra cost for the charger and relies on the user to properly place the mouse in the cradle for recharging.

In view of the above, there is a need for wireless, battery-powered computer mice capable of providing a built-in backup system that avoids the loss of functionality, while also informing the user that a critical discharge level is approaching and indicating the status of discharge.

### BRIEF SUMMARY OF THE INVENTION

The present invention provides a wireless mouse suitable for use with a computing device, such as a personal computer, laptop, notebook, etc., as well as a method of using such a mouse.

According to a first aspect of the invention, the mouse includes a housing, electronics within the housing for sensing movement of the mouse and wirelessly communicating with the computing device, at least two batteries within the housing, a device for monitoring a power level of each of the batteries, and a device for switching between the batteries to deliver electrical power from one of the batteries to the electronics. Each battery is adapted for individually powering the electronics, and the switching device operates to switch from a first of the batteries to a second of the batteries when the power level of the first battery sensed by the monitoring device drops below a preset depletion threshold value.

According to a second aspect of the invention, the method of operating the wireless mouse entails using the wireless mouse, observing a signal that indicates when the switching means has operated to switch from the first battery to the second battery when the power level of the first battery sensed by the monitoring means drops below a preset depletion threshold value, and then replacing the first battery with a third battery.

A significant advantage of this invention is that the wireless mouse does not suddenly stop operating in the event the battery from which it draws power no longer has sufficient power to supply and operate the electronics of the mouse. Instead, the mouse can continue to be used without interruption. The mouse is preferably equipped to signal the user that the supply power has been switched from one battery to another, and that the previous supply battery is depleted and should be replaced or recharged. The mouse preferably maintains full functionality with a single battery or battery pack, and can be used with non-rechargeable (primary) batteries. The invention can also be implemented with rechargeable (secondary) batteries, with or without a cradle for recharging the batteries while in the mouse.

Other objects and advantages of this invention will be better appreciated from the following detailed description.

### BRIEF DESCRIPTION OF THE DRAWINGS

FIG. 1 schematically represents the outline of a computer mouse and a switching system for connecting either of two batteries to power the mouse.

FIG. 2 schematically represents the batteries of FIG. 1 equipped with voltage sensors connected to a low-battery indicator control logic.

### DETAILED DESCRIPTION OF THE INVENTION

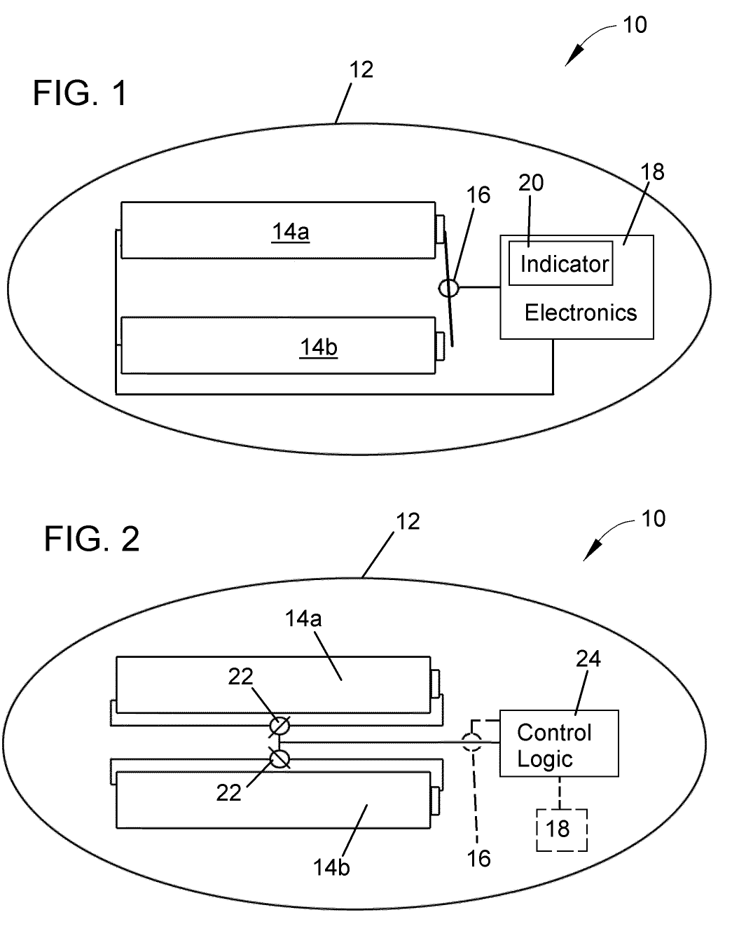

FIGS. 1 and 2 represent a wireless, battery-powered mouse 10 of this invention and of a type suitable for use with a computer, including but not limited to personal computers, laptops, notebooks, etc. The mouse 10 may be an optical mouse that relies on LEDs to sense movement of the mouse 10 for translation into X-Y coordinates on a computer screen. The mouse 10 wirelessly communicates with the computer (or other device), such as by RF communication with a receiver associated with the computer, for example, plugged into a USB port of the computer. The mouse 10 relies on battery power as its sole or primary power source under standard operating conditions.

In FIGS. 1 and 2, the mouse 10 is shown as comprising a lower housing 12 in which a pair of batteries 14a and 14b are installed. The batteries 14a and 14b may be individually installed or part of a battery system, such as a battery pack. Furthermore, while two batteries 14a and 14b are shown, it is within the scope of the invention that additional batteries could be provided. The batteries 14a and 14b are preferably replaceable, meaning that they are intended to be and can be removed and replaced with other batteries by the user. Alternatively or in addition, the batteries 14a and 14b may be rechargeable (secondary) batteries of any suitable type known in the art.

The mouse 10 is equipped with a switching mechanism 16 adapted to connect and disconnect the batteries 14a and 14b from electronics 18 within the housing 12 that perform various functions of the mouse 10, such as sensing, wireless signal transmission to a computer (not shown), and LED operation (if applicable). The switching mechanism 16 is represented as a single-pole, double-throw (SPDT) type switch, but could be another suitable type known in the art. Both batteries 14a and 14b are of a sufficient voltage to individually power the electronics 18. As such, only one of the batteries (14a in FIG. 1) is connected via the switching mechanism 16 to the electronics 18 of the mouse 10 at any given moment during standard operating conditions, while the remaining battery (14b in FIG. 1) is disconnected from the electronics 18 to avoid discharge. As a point of reference, the battery powering the electronics 18 (14a in FIG. 1) will be referred to as a supply battery, and the remaining battery (14b in FIG. 1) will be referred to as a backup battery. Such a naming protocol is not intended to indicate the locations of the batteries 14a and 14b within the housing 12.

FIG. 1 shows the housing 12 as being equipped with an indicator system 20 that provides the user with a signal regarding the operating mode of the batteries 14a and 14b. The indicator system 20 is schematically represented as part of the electronics 18 in FIG. 1, though the system 20 could be entirely separate from the electronics 18. When the mouse 10 switches to draw power from the backup battery (14b in FIG. 1), the indicator system 20 preferably provides a temporary or continuous signal to indicate that the mouse 10 is operating on “backup” power. The signal provided by the indicator system 20 may be a visual warning, such as a light (e.g., LED) on the mouse 10, or another visual warning such as a message displayed on the computer monitor via software installed on the computer, and/or an audible signal. Particularly if the visual warning is a message displayed on the computer monitor, the warning may include an indication as to which of the batteries is powering the electronics and/or which battery should be replaced.

Shown separately in FIG. 2 for purposes of clarity, voltage sensors 22 or one or more similar sensing devices are provided within the housing 12 for monitoring the residual charges of the batteries 14a and 14b. The sensors 22 may be voltmeters capable of measuring the output voltages of the batteries 14a and 14b to determine their state of charge. The outputs of the sensors 22 are received by a control logic 24 that compares the output of the battery 14a/14b currently powering the mouse 10 (14a in FIG. 1) against a preset depletion threshold value, which is preferably selected to be at or above a voltage level at which the mouse 10 and its electronics 18 would stop operating. As the charge of the battery 14a nears or drops below the threshold, the control logic 24 instructs the switching mechanism 16 (shown in phantom in FIG. 2) to disconnect the supply battery 14a from the electronics 18 of the mouse 10 and immediately connect the backup battery 14b. When the backup battery 14b is connected and the supply battery 14a is depleted, the indicator system 20 preferably signals the user that the mouse 10 is running on backup power and, consequently, the battery 14a should be replaced or recharged whenever it is convenient for the user.

The control logic 24 preferably identifies the new battery replacing the depleted battery 14a as the backup battery, whereas the former backup battery 14b now functions and is designated as the supply battery for the mouse 10. For example, when a new battery of sufficient charge (its power level sensed by its sensor 22 is above the preset depletion threshold value) is installed in place of the depleted battery 14a, the control logic 24 may reset to terminate the signal of the indicator system 20. The control logic 24 is also preferably capable of allowing the mouse 10 to operate normally if the first battery 14a is removed but not replaced with a new battery, and may provide an additional and different type of warning if one of the batteries 14a or 14b is absent. If rechargeable batteries are used, the invention may further include a cradle (not shown) in which the mouse 10 can be placed to directly recharge both or at least the depleted battery during off-hours.

While the invention has been described in terms of a preferred embodiment, it is apparent that other forms could be adopted by one skilled in the art. For example, the physical configuration of the mouse 10 and its internal components could differ from those shown, and various materials and processes could be used to produce the mouse 10 and its components. Therefore, the scope of the invention is to be limited only by the following claims.

1. A wireless mouse for use with a computing device, the wireless mouse comprising:
a housing;
electronics within the housing for sensing movement of the mouse and wirelessly communicating with the computing device;
at least two batteries within the housing, each of the batteries being adapted for individually powering the electronics;
means for monitoring a power level of each of the batteries; and
means for switching between the batteries to deliver electrical power from one of the batteries to the electronics, the switching means operating to switch from a first of the batteries to a second of the batteries when the power level of the first battery sensed by the monitoring means drops below a preset depletion threshold value.

2. The wireless mouse according to claim 1, wherein the monitoring means comprises a voltage sensor.

3. The wireless mouse according to claim 1, wherein the monitoring means comprises a control logic for comparing the power level of at least the first battery to the preset depletion threshold value.

4. The wireless mouse according to claim 1, further comprising means for indicating which of the batteries is powering the electronics.

5. The wireless mouse according to claim 4, wherein the indicating means comprises means for generating a visual signal on the mouse that signals which of the batteries is powering the electronics.

6. The wireless mouse according to claim 4, wherein the indicating means comprises means for generating a visual signal capable of being displayed on a computer monitor to signal which of the batteries is powering the electronics.

7. The wireless mouse according to claim 4, wherein the indicating means comprises means for generating an audible signal.

8. The wireless mouse according to claim 1, further comprising means for indicating when the switching means operates to switch from the first battery to the second battery.

9. The wireless mouse according to claim 8, wherein the indicating means comprises means for generating a visual signal on the mouse to signal when the switching means operates to switch from the first battery to the second battery.

10. The wireless mouse according to claim 8, wherein the indicating means comprises means for generating a visual signal capable of being displayed on a computer monitor to signal when the switching means operates to switch from the first battery to the second battery.

11. The wireless mouse according to claim 8, wherein the indicating means comprises means for generating an audible signal to signal when the switching means operates to switch from the first battery to the second battery.

12. The wireless mouse according to claim 1, further comprising means for indicating when the power level of the first battery drops below the preset depletion threshold value.

13. The wireless mouse according to claim 12, wherein the indicating means comprises means for generating a visual signal on the mouse to signal when the power level of the first battery drops below the preset depletion threshold value.

14. The wireless mouse according to claim 12, wherein the indicating means comprises means for generating a visual signal capable of being displayed on a computer monitor to signal when the power level of the first battery drops below the preset depletion threshold value.

15. The wireless mouse according to claim 12, wherein the indicating means comprises means for generating an audible signal to signal when the power level of the first battery drops below the preset depletion threshold value.

16. The wireless mouse according to claim 1, wherein the batteries are replaceable.

17. The wireless mouse according to claim 1, wherein the batteries are rechargeable.

18. A method of operating the wireless mouse according to claim 1, the method comprising:
using the wireless mouse;
observing a signal that indicates when the switching means operates to switch from the first battery to the second battery when the power level of the first battery sensed by the monitoring means drops below a preset depletion threshold value; and then
replacing the first battery with a third battery.

19. The method according to claim 18, wherein after the first battery is replaced, the second battery continues to power the electronics and the method further comprises continuing to use the wireless mouse prior to replacing the first battery.

20. The method according to claim 18, further comprising the step of terminating the signal when the first battery is replaced with the third battery.

21. The method according to claim 20, wherein the signal is terminated after the first battery is replaced with the third battery on the further condition that the third battery has a power level above the preset depletion threshold value.
